(19) United States
(12) Patent Application Publication
(10) Pub. No.: US 2013/0232138 A1
(43) Pub. Date: Sep. 5, 2013

(54) METHOD AND APPARATUS FOR AGGREGATING SERVER BASED AND LAN BASED MEDIA CONTENT AND INFORMATION FOR ENABLING AN EFFICIENT SEARCH

(71) Applicant: Kerry Wayne Calvert, San Diego, CA (US)

(72) Inventor: Kerry Wayne Calvert, San Diego, CA (US)

(73) Assignee: THOMSON LICENSING, Issy de Moulineaux (FR)

(21) Appl. No.: 13/885,695

(22) PCT Filed: Nov. 18, 2011
(86) PCT No.: PCT/US2011/061346

§ 371 Date: May 16, 2013

Related U.S. Application Data
(60) Provisional application No. 61/415,468, filed on Nov. 19, 2010.

(51) Int. Cl. G06F 17/30

(52) U.S. Cl. CPC G06F 17/30519
USPC 707/722; 707/758

(57) ABSTRACT

A method and apparatus for aggregating server based and LAN based media content and information for enabling an efficient search include discovering local and external content directory service instances, storing at least one of content of the discovered content directory service instances and metadata identifying content available via the discovered content directory service instances in a common database and providing a user interface such that a user is able to search for content across the discovered content directory service instances. In one embodiment a common database comprises a de-serialized database which provides use of indexes for enabling searches.

### CROSS-REFERENCE TO RELATED APPLICATIONS

This application claims the benefit of U.S. Provisional Application Ser. No. 61/415,468, entitled “METHOD FOR AGGREGATING SERVER BASED AND LAN BASED MEDIA DICTIONARY FOR EFFICIENT SEARCH”, filed Nov. 19, 2010, which is incorporated by reference herein in its entirety.

### FIELD OF THE INVENTION

The present invention generally relates to content management systems and, more particularly, to a method and apparatus for creating a directory of media assets from multiple sources for enabling an efficient search.

### BACKGROUND OF THE INVENTION

Content/data can be stored on any number of different devices. Sharing such content across various devices, however, can sometimes be limited to sharing content/data across local networked devices. For example, the Digital Living Network Alliance (DLNA) vision for sharing content/data in a home network is predicated on assets that exist solely in a local area network (LAN). Often times, however, it can be desirable for content/data to be available and downloadable from servers outside of the LAN. For example, commercial entities desire a means to make available a portal to media that can be streamed or downloaded to the LAN in a transaction model that generates revenue for the provider. A common way to unify content/data from multiple sources outside of a LAN includes importing content/data into a common database and utilizing replication to bring server based data into the local system. This approach, however, has scalability problems for the server side in that too much network bandwidth and server computational resources are needed to replicate content/data to multiple clients. In addition, such an approach requires a client to maintain a large storage capacity, which is not feasible from a cost and ergonomic perspective in present consumer devices.

Alternate available approaches require a client to visit and search multiple portals to search for content/data, which is time consuming and inefficient.

### SUMMARY OF THE INVENTION

Embodiments of the present invention address the deficiencies of the prior art by providing a method and apparatus for creating a directory of data assets from multiple sources for enabling an efficient search.

In one embodiment of the present invention, a method for creating a directory of data assets from multiple sources for enabling an efficient search includes discovering local and external content directory service instances, storing at least one of content of the discovered content directory service instances and metadata identifying content available via the discovered content directory service instances in a common database and providing a user interface such that a user is able to search for content across the discovered content directory service instances.

In an alternate embodiment of the present invention, an apparatus for creating a directory of data assets from multiple sources for enabling an efficient search includes

### BRIEF DESCRIPTION OF THE DRAWINGS

The teachings of the present invention can be readily understood by considering the following detailed description in conjunction with the accompanying drawings, in which:

FIG. 1 depicts a high level block diagram of a system for aggregating remote and local media dictionary for efficient search in accordance with an alternate embodiment of the present invention;

FIG. 2 depicts a result of a sorting of partial data sets of two devices;

FIG. 3 depicts a high-level block diagram of a view that has been defined to aggregate video content search results in accordance with an embodiment of the present invention;

FIG. 4 depicts a high-level block diagram of a view that has been defined to aggregate video content search results in accordance with an alternate embodiment of the present invention;

FIG. 5 depicts a flow diagram of a method for aggregating content from local and remote sources for enabling the performance of an efficient search in accordance with an embodiment of the present invention; and

FIG. 6 depicts a high level block diagram of a CMS device 600 for aggregating server based and LAN based media content and information for enabling an efficient search in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method and apparatus for creating a directory of data assets from multiple sources and enabling optional preferential ordering of such assets based on rules. Although the present invention will be described primarily within the context of a Digital Living Network Alliance (DLNA) content management system and DLNA/UPnP Content Directory Service (CDS) components, the specific embodiments of the present invention should not be treated as limiting the scope of the invention. It will be appreciated by those skilled in the art and informed by the teachings of the present invention that the concepts of the present invention can be advantageously applied in any commercial or residential environment for managing content using other formats and proxies other than DLNA and CDS components.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

In one embodiment of the present invention, a Content Management System (CMS) of the present invention provides local devices and DLNA control points with the ability to search and store media content and metadata on a local device, and on DLNA compatible devices discovered in the LAN. In one embodiment of the present invention, every source of content models a DLNA/UPnP Content Directory Service (CDS), and supports the services defined by the UPnP committee for a CDS implementation. This includes search, browse, sorting, ordering, eventing, storing, copying, deletion, and data modeling. Such core features are defined in the ContentDirectory:3 Service Template Version 1.01 specification which can be found at http://www.upnp.org/specs/av/UPnP-av-ContentDirectory-v3-Service.pdf.

In such an embodiment described above, the CMS of the present invention comprises an aggregator of CDS instances, which it manages through logical views that define which CDS instances are to be included in an aggregation. Requests for services (e.g., searches/queries) from the CMS are performed through these logical views, and the CMS will handle the details of interfacing with each CDS in the view such that the consumer of CMS services is logically operating with a single control entity and result set from queries.

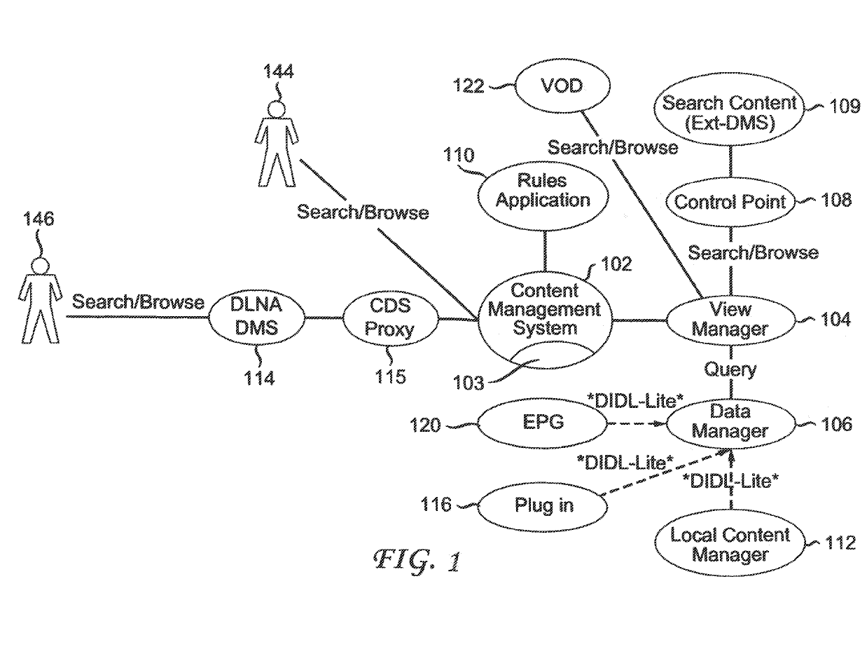

FIG. 1 depicts a high level block diagram of a system 100 for aggregating remote and local media dictionary for efficient search in accordance with an embodiment of the present invention. The system 100 of FIG. 1 illustratively comprises a content management system (CMS) 102, a view manager 104, a data manager 106, a control point 108 and an optional rules applicator 110. In the system 100 of FIG. 1, the CMS 102 presents an API to consumer components interested in searching for content. The CMS 102 provides the management interface to expose and create views. The CMS 102 provides search, update, and delete interfaces for content metadata when allowed. The CMS 102 implements an API to support the DLNA CDS functions. In various embodiments, the CMS invokes the optional rules components to process result sets prior to presentation of the results to the requesting clients. That is, the CMS 102 enables optional preferential ordering of collected assets based on rules.

In the embodiment of the system 100 of FIG. 1, the View Manager 104 creates and manages content hierarchies/views, and applies search and update requests to them. The view manager 104 establishes connections to components called out in the view definitions and uses the components to bring content into the result sets for queries or to apply updates. The view manager 104 uses the view definitions to determine the strategy for content management of the content providers.

The Data Manager 106 of the system 100 presents an abstraction to components for search and updating the persistent storage used for storing metadata and content directories.

The CMS 102 relies on the Control Point 108 (e.g., DLNA control point) to discover DLNA devices that are in the LAN. The Control Point 108 provides a common interface for all known (as defined above) components. The CMS 102 uses the Control Point 108 to discover other CDS instances in the LAN and to implement the control and data interface to discovered devices through a DLNA stack and external DMS 109.

The optional Rules Applicator 110 implements data manipulation of query result sets. The Rules Applicator 110 is implemented by the CMS 102 to operate on a query result set, and the CMS 102 passes the processed results on to its users. That is, as described above, the CMS 102 enables optional preferential ordering of collected assets based on rules. In alternate embodiments of the present invention, a system can have multiple rules applicators defined, and a CMS view definition that defines which rules applicators and the order in which the rules should be applied will be used to generate a result set. Rules to be applied to resulting search sets can include rules on the ordering of a presentation of search results or what content/metadata to present or not present to a user.

The system 100 of FIG. 1 can further include a Local Content Manager 112 which provides an API for known components to add media and metadata to a common database 103, illustratively in FIG. 1 located in the CMS 102. The Local Content Manager 112 is able to scan media files to extract embedded metadata and perform services such as caching image files/thumbnails in the common database. In one embodiment of the present invention, metadata is mapped into a DIDL-Lite form, and presented to the Data Manager 106 for persistent storage and view management. In such an embodiment, the Data Manager 106 receives requests to update, insert, and delete content, and uses a Local Content API to perform cache management on modified content.

The system 100 of FIG. 1 can receive content and metadata from external content providers or services such as an EPG, a camera, a USB drive, etc. Such content providers provide content provider plug-ins 116. The content provider plug-in 116 provides specialized knowledge about a device type or service (EPG, camera, USB drive, etc). In one embodiment, the Content Provider plug-in 116 abstracts its device's content metadata into a DIDL-Lite form and presents the data to the Data Manager 106 for persistence management. The Content Provider plug-in 116 provides the functionality to mark the content and its associated metadata as “offline” when the device is detached, and re-enable and update the cached data when the device is re-attached. It also provides purging functionality for cached data.

In the system 100 of FIG. 1, the Content Management System 102 accepts search requests from clients through its exposed API. Known components access the CMS 102 directly through its API. External UPnP users see the CMS 102 as proxied through an associated local digital media server (DMS) 114 and CDS proxy 115. A known component can select different views of content, where a UPnP client has no concept of a view and will see the results as defined by a default view. As described above, a known component/device is a component/device whose content and/or metadata is stored in the central/common database already.

In the system 100 of FIG. 1, the CMS 102, the View Manager 104, Data Manager 106, and the Local Content Manager 112 are illustrated as separate components to assist in illustrating and explaining the various functionalities of a system of the present invention. However, in alternate embodiments of the present invention, the functionalities of one or all of the components, the CMS 102, the View Manager 104, Data Manager 106, and the Local Content Manager 112, can be implemented in a single device considered, in one embodiment, a CMS 102 of the present invention. In addition, although in the system 100 of FIG. 1 the common database 103 is illustratively located in the CMS 102, in alternate embodiments of the present invention, the common database 103 can comprise a separate component or alternatively can be integrated into any other component of the system 100 of FIG. 1.

For example, in an embodiment of the present invention, the CMS 102 aggregates content and metadata in a common database for enabling efficient searching of LAN-based and Server-based content. More specifically, in an embodiment of the present invention, the CMS of the present invention discovers all local and external CDS instances to aggregate content and metadata in a common database for enabling efficient searching of LAN-based and Server-based content. In various embodiments of the present invention, local CDS instances, such as the EPG 120 and VOD 122 of FIG. 1, can be discovered directly through an API or through an associated local digital media server (DMS) 114. In addition, in one embodiment of the present invention, a CMS can discover external CDS instances using content provider plug-in components, such as the Plug-In 116 of FIG. 1, that will implement the actual interfaces to the content media and metadata. Some examples of plug-ins can include a Program Database, a Recording Manager, and various external services. Each plug-in will have a proprietary API that the CMS codes to and it is the responsibility of the CMS to transform data extracted from the plug-ins and store such information into a common database system, for example in one embodiment using SQLite (described in more detail below).

In various embodiments of the present invention, components able to interface with the CMS implement the UPnP search and browse syntax if such components are to be included in views that get exposed to DLNA requests. In addition to the content provider plug-ins, in an embodiment the CMS can discover external CDS instances by interfacing with a DLNA control point component (running locally), such as the control point 108 of FIG. 1. The CMS uses the control point's data model to discover external CDS devices, and will use the control point's interfaces to exchange information and data with those devices.

In addition to discovering CDS instances, the CMS stores at least one of content of the discovered content directory service instances and metadata identifying content available via the discovered content directory service instances in a common database. In one embodiment of the present invention, the common database of the present invention comprises an XML database that has the ability to generate indexes to support XQuery based access mechanisms. For example, in one embodiment, the common database can comprise Berkeley DB or eXist XML database. There are, however, cost issues with using the Berkeley DB solution, and eXist requires a Java SDK implementation.

As such, in a preferable embodiment, the common database comprises a SQLite database. Metadata that is stored in the SQLite database is de-serialized into a relational model. This provides the benefit of the use of indexes to support search and ordering requests, which avoids the necessity for a serial scan of the entire data set.

It should be noted that for systems including remotely located (server based) repositories of data and metadata, such as VOD systems, the data and metadata is not ingested, and result sets must be collected separately and merged with locally gathered results. For metadata not able to be stored in the common database, the CMS of the present invention is capable of querying metadata through plug-ins to such content providers. In one embodiment of the present invention, the CMS does support update, deletion, or creation of metadata in such plug-ins, unless those plug-ins have a supporting API, and such metadata extracted from plug-ins are presented as “read only” objects to clients searching using the CMS of the present invention.

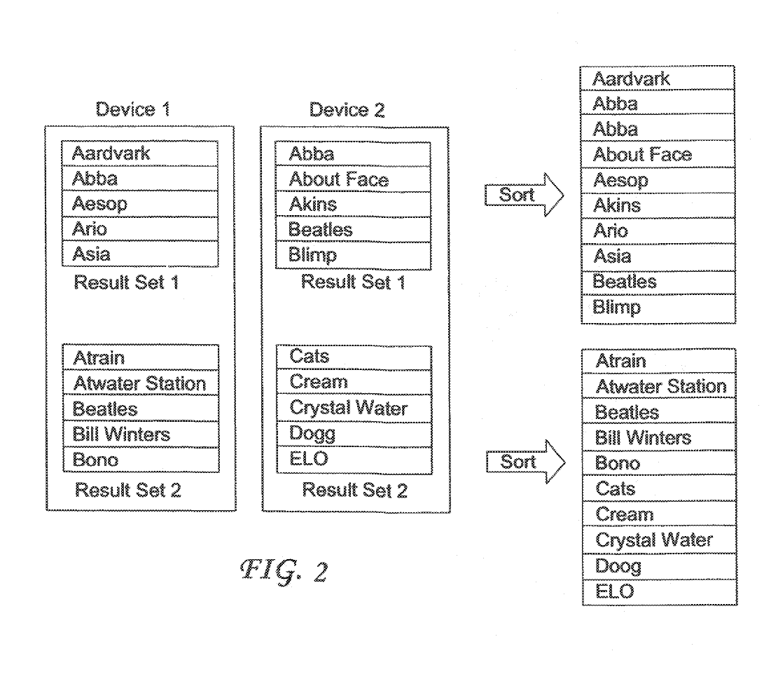

Accordingly, the query strategy of the present invention accounts for the need to collect data from disparate providers, and the data is merged, sorted, and ordered in accordance with various embodiments of the present invention described below. When this is done, however, there is complexity introduced because in the normal access method, the result sets being merged can be partial result sets, which require processing logic to insure the merged result is correct. It is a normal practice in UPnP request operations to limit the result set extracted to X records, starting at record number Y in the list. This creates the potential for a sorting/grouping problem as illustrated in FIG. 2.

That is, FIG. 2 depicts a result of sorting of partial data sets of two devices. In the example of FIG. 2, Device 1 and Device 2 are queried for content, with a sort on Artist Name. Each request for data is limited to 5 records. The result sets returned from each device is grouped into 5 items, with the relative order of extraction illustrated by the vertical sequence illustrated in FIG. 2. In the embodiment of FIG. 2, if the contents from Result Set 1 of device 1 and device 2 were simply merged, the first result set returned to the consumer would be correct. However, as depicted in FIG. 2, the second request would result in the repetition of terms starting with “A” Device 1′s results, creating confusion and incorrect sort order over the total result scan.

As such, in various embodiments of the present invention, the CMS pulls enough data from each device in a query to insure that the correct ordering of data is presented. This requires the CMs to send multiple requests to a device to extract data until the output result set count boundary is reached, or until it is clear that the values being returned are preceded by items from other devices.

For various embodiments of the present invention the location of data has a significant performance impact on the approach by which search, sort, and filtering operations are performed and some of those approaches are discussed below.

### Majority of Content is Locally Stored

The following sequence describes a use case where a system has the majority of its metadata stored in a local SQLite database on the system executing the CMS, where the number of data items on plug-in devices or external CDS instances are small in comparison. When a query request is received, processing time will be minimized by:
1) Merging the smaller result sets into a common database (e.g., SQLite database)
2) Running query on database
3) Using database to perform sorting and grouping operations (SQLite, stored procedures, views)
4) Use the query handle to iterate result sets to the consumer

Performing a query in this manner uses a large number of performance features that are internal to the database implementation. The database utilizes caching techniques and indexes to minimize the memory and disk I/O needed.

In an alternate embodiment XQuery can be used instead (without the support of an XML database), however, a linear search over the entire data set is performed, and results are copied to a result set. That is, in one embodiment of the present invention, sorting and ordering can be performed with XQuery from memory resident data. This results in serial scans and memory copying of the data which will be expensive on large datasets. This approach is much less efficient than a SQLite query that generates a vector tree so that data is only copied when it is explicitly called for in the query result iteration. With XQuery there is no caching, other than the OS cache for its open files. Additionally, the use of XQuery will require that a customized iteration and data merge management of the result set be built. However, because in some applications the search usage model limits the number of records in result set (explained in more detail below), this can be an acceptable tradeoff.

### Majority of Data is Stored Externally

When the data is located on a device that is remote from the CMS instance, the cost of the search processing is born by the external device. That is, in one embodiment of the present invention, when the desired data is collected from the network, it is located in memory, in a form suitable for searching with XQuery/XPath. The cost of inserting this data into a sparsely populated database of local content in order to gain the use of indexing for searches may not be warranted. Merging the external results with local content in memory, and performing an XQuery operation can provide the quickest turnaround.

### Hybrid Strategy

Given the conflict of benefits/costs implicit from either SQL or XQuery processing models in the described use cases, in one embodiment of the present invention a hybrid approach to querying and processing data that can be configured or selected is implemented. The selected configuration would be for either a distributed or a centralized data storage model.

For example, in a centralized model, the data storage interfaces will aggregate all metadata from local, known devices in a single database. There will be a “replicator” that discovers unknown CDS services in the LAN, and will replicate their metadata instances and use the UPnP eventing model to keep the data synchronized.

For content providers, such as VOD providers, whose content inventory is too large to practically ingest into the database, the CMS instances will merge result sets extracted from the database with results collected from the non-replicated providers.

In the distributed model, there is no content ingestion into a centralized database. The CMS queries all CDS instances found in the LAN, and merges the result sets with its locally managed metadata. That is, the CMS instance determines from its configuration the set of content providers it has. When operating in the Distributed Data Model, a control point discovers CDS instances in the LAN, and publishes those instances so that the CMS is aware of the content providers that it can access. Specific internal components, such as a VOD instance, and the Storage Manager will register their presence, and the CMS will include them as CDS instances that it manages. Each CDS instance is treated as a query processor that will support the UPnP API for Content Directory Services. The CMS manages all data aggregation from the CDS sources through a hierarchy that is defined by a view (as described above and further below). The CMS creates a default view, which consists of all CDS instances with a single “virtual” CDS. The CMS consumer can then selectively define views by which to organize the content.

The only difference between the Distributed and Centralized Data Model is the CMS instance no longer has a Control Point publishing CDS instances for it to manage. All data that is persisted is accessed through the Storage Manager. This allows all metadata to be queried from a central repository, with the exception of those metadata sources that are not persisted in the database, such as VOD instances. This architecture is more efficient for querying content when there are numerous CDS instances in the LAN, and there are suitable resources for aggregating all of the metadata in a single database.

In one embodiment of the present invention, a Control Point is configured to interface with a Replicator component. The Replicator ingests metadata from external DLNA devices, and merges it into a shared database with other metadata. It subscribes to eventing for content changes with DLNA devices that it discovers in order to keep the database in sync. When the Replicator discovers a DLNA device that identifies itself as a known device, it will not enter into the content replication/eventing model with that device. Known devices are devices whose metadata is stored in the central database already.

In accordance with various embodiments of the present invention, searching and browsing content can be accomplished by providing a user with a user interface. In various embodiments of the present invention, such user interface can comprise a graphical representation of one or more views of the content. In accordance with one embodiment of the present invention, a view comprises a hierarchical representation of content. A view defines the grouping and sorting criteria that is used to present content. In one embodiment, the definition of a view is expressed in an XML syntax, and the CMS keeps a repository of view definitions that it manages. A view node is associated with specific CDS instances, such that the source of data for that branch of the hierarchy can be controlled. In one embodiment, view nodes are defined by conditional logic that uses content metadata to determine whether an item should be included as a child of the node. In one embodiment, a view may limit the CDS devices to internally managed content only, while an alternate embodiment of a view can include external DLNA devices discovered, and an alternate embodiment of a view can limit itself to electronic program guides (EPG) or video on demand (VOD). In accordance with embodiments of the present invention, a user can decide how to construct the view they would like to operate on, and they can change their view dynamically, and operate on multiple views simultaneously.

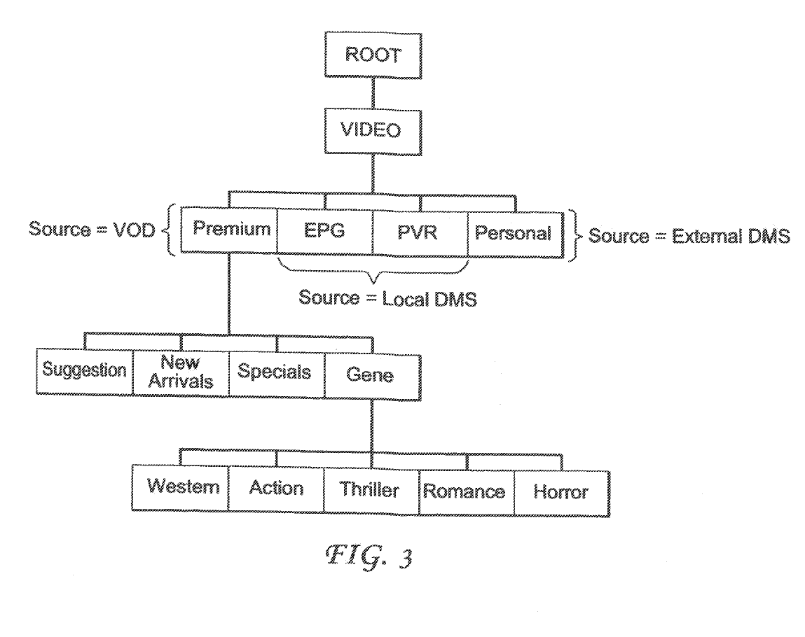

FIG. 3 depicts a high-level block diagram of a view that has been defined to present aggregated video content from, for example a search result, in accordance with an embodiment of the present invention. The content of FIG. 3 is organized into Premium, EPG, PVR, and Personal categories. In the embodiment and example of FIG. 3 only the sub-hierarchy of the Premium node has been illustrated. The other video node categories can be defined to have similar or completely different hierarchy nodes.

For the purpose of explaining the embodiment of the present invention of the example of FIG. 3, the Premium category is illustratively sourced from a server based application, and the EPG and PVR categories are sourced from a local DMS, and the Personal category is sourced from a PC that has a generic DMS exposed. The exemplary view in FIG. 3 has a relationship between the physical source of content and its logical representation that enables a more optimal response time to requests. In FIG. 3 it is clearly illustrated how content providers can be removed from request processing based on the location in the content hierarchy where the search is performed. Such action is illustrated in FIG. 3 using the color coding of the hierarchy nodes.

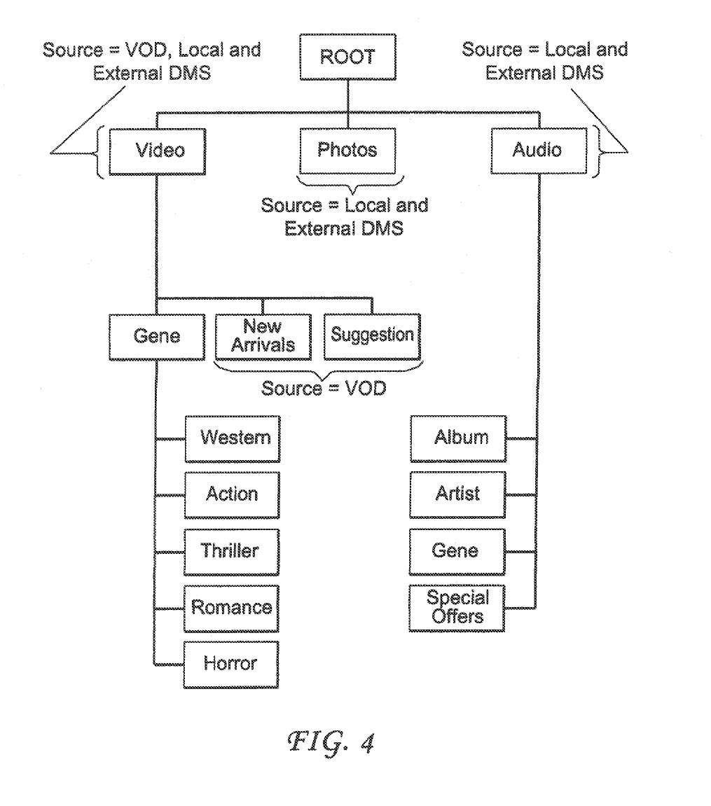

FIG. 4 depicts a high-level block diagram of a view that has been defined to aggregate video content search results in accordance with an alternate embodiment of the present invention. The view of FIG. 4 is logical in organization, such that content from different sources is merged in the hierarchy. For example, in the “genre” category, content from a VOD provider, local content, and external DMS is populated in the hierarchy according to the metadata. The only source for “New Releases” and “Suggestions” is the VOD server, so those nodes are defined to receive content specifically from the VOD and not send search/browse requests to CDS instances that would never return results for the category. In the embodiment of FIG. 4, the same configuration applies to the photo and audio categories.

Logical view segments are those portions of the hierarchy that combine data from multiple CDS instances. For example, in FIG. 4 the “Video/Genre” node is logical because it combines content from VOD, Local, and External DMS sources. In one embodiment of the present invention, such segments will be automatically assigned the DLNA restricted property, to prevent modification. In addition, view nodes can be manually defined as restricted in the view definition XML. For example, the “New Releases” node in FIG. 4 can be defined as restricted if the VOD service does not accept updates from clients for such data.

It should be noted that it is possible to define rules of a view such that data elements presented from a CDS instance have no slot in the hierarchy. For example, if the node definitions for genre are based on matching values from the content metadata into a discrete list of values, such as “Action”, “Thriller”, etc, and a content item has a genre value not in the list, the content item will not appear in the view. If this is not intended behavior, then rules specifications for the node should have a wildcard node for items not accounted for in the discrete rules.

In various embodiments of the present invention, there are three classes of content providers in a view:
1) Content that is stored locally to the CMS that is always available.
2) Content that is server based or too large (VOD is an example) and cannot be cached.
3) Content that is on external devices that may go online and offline, and is cacheable, but for which the state of availability must be accounted.

In one embodiment of the present invention, when defining a view, the content providers are classed as to the type of cache with which they are implemented. Once the view is constructed, the cacheable content and hierarchy is persisted, and DLNA event notification is used to keep it synchronized with its source provider. When a provider goes offline and then comes back online, the cache must be resynchronized. While the provider is offline, its cache is retained, but it is marked offline and not available for searching or browsing. If a provider goes offline, and never comes back, then its cache will be deleted based on aging and/or space considerations. In one embodiment of the present invention, the data that is cached for offline providers is the content hierarchy tree, represented as a nested set model and the metadata that describes the content is referenced in the hierarchy tree.

In various embodiments of the present invention, searches generate a result set with a temporary lifespan and result sets will eventually be discarded. The result set is referred to as a Search Context Instance. In one embodiment, the lifecycle of the Search Context Instance is from the time of the initial search request until a different search request from the same control point is received. The search Context Instance contains references to the actual content items contentID value and does not contain the data itself. The Search Context Instance of the present invention is a hierarchical data model that organizes virtual content identifiers extracted from the search request per the organizational and sorting rules defined by the view (described above). Virtual content identifiers and hierarchies are discussed below.

Alternatively, a component can save a Search Context Instance from destruction and re-enable it for iteration/browsing, allowing the component to manage multiple search requests simultaneously. The default Search Context Instance destruction mechanism accounts for external UPnP control points that are not cognizant of the extended view processing occurring behind the scenes of their standard DLNA CDS requests.

For example, referring back to the embodiment of FIG. 3, when a search request is received that specifies the “Video” node as the starting point for the search, the request is sent to the “VOD” provider. The request is applied to the view's cache, specifying the “Video” node as the starting point of the search, and the result sets are merged to construct the Search Context Instance. An issue with collecting adequate content from each provider requires that enough content is pulled from a non-cached provider to insure the virtual tree is populated correctly as discussed above. This will potentially result in a given provider or providers being queried multiple times per single search request iteration to collect enough data to populate the view segment correctly.

When adequate results are collected to fulfill the search request, a DOM is constructed of items and containers, such as in one embodiment, DIDL-Lite items and containers. If rules components are installed, the DOM is sent to the rules processors. Once rules processing is complete, the DOM is transmitted to the requesting control point. As the search request is iterated through, the incremental data received from the non-cached providers is merged with the search instance data, and the results parceled out to the control point per its search request parameters. The Search Context Instance is then discarded per the direction of a component or the receipt of a new search request from the same control point.

Referring back to FIG. 1, as described above, the CMS 102 aggregates content and metadata in a common database for enabling efficient searching of LAN-based and Server-based content. That is and as described above, the CMS of the present invention discovers all local and external CDS instances to aggregate content and metadata in a common database for enabling efficient searching of LAN-based and Server-based content. The CMS then accepts search requests from clients through its exposed API. Known components access the CMS directly through its API. External UPnP users see the CMS as proxied through an associated local digital media server (DMS). A known component can select different views of content, where a UPnP client has no concept of a view and will see the results as defined by a default view. For example, in FIG. 1, a known consumer/client 142 submits a search request directly to the CMS 102 through its API using a provided user interface (e.g., hierarchical logic tree) as described above in, for example FIG. 3 and FIG. 4. Alternatively, an unknown consumer/client 144 submits a search request to the CMS 102 via a local DMS 146 using the provided user interface (e.g., hierarchical logic tree).

In either instance, the search request received from the consumer is sent to each CDS instance that is registered and included in the consumer's view. For example, in such cases, each of the searches are processed individually by the CDS instance, and the result set is aggregated into a single document object model (DOM) along with results collected from the CMS managed content and metadata database. In an embodiment of the present invention, the wisest use of resources is accomplished by leaving up to the individual component implementations. In such embodiments, the components are aware that the result sets they create are being copied into the CMS for processing into an aggregate DOM, and that they should implement a solution that only applies the search processing once in a data request/iteration sequence and that resource consumption should be minimized to process query results as much as possible.

In one embodiment of the present invention, the data extracted from the CDS instances is a DIDL-Lite compliant XML document. Each item has a unique identifier that is assigned by the content provider. The results from each provider are aggregated into a single dataset. Each item in the aggregate set must have a unique identifier. The identifiers are virtualized to maintain unique identifiers in the result set that can be referenced back to the unique identifier assigned by the content provider to the item.

In various embodiments of the present invention, the search requests from the CMS consumers limit the number of records to return, and iterate over the result set. The CMS instructs the content providers to present results in the sort order requested by its consumer. As in the search operation, the content providers perform the sort on their result set just once over the life of the CMS iterating over the result set. The CMS merges the results from the different content providers into a sorted list on each fetch iteration.

In one embodiment of the present invention, the view specification is an XML document, and processing logic follows the XML hierarchy from top to bottom, and left to right. Requests for data are sent to the declared datasources at points in the hierarchy where content segments are declared. The query constructed will reflect all match specifications that have been declared on each ancestor node in the hierarchy for the content declaration. When the XML specifies a group, it is treated as a DIDL-Lite container. The container name (title) is either declared statically in the XML with a ‘name’ attribute, or if the ‘derivedName’ attribute is declared, the container name is extracted from the specified property for a content item that meets the match condition specified for the group. When the XML specifies a content segment, a query is constructed and sent to each non-cached datasource declared in the hierarchy path. The results from these queries are organized into a result set, with ordering rules specified in the view specification applied.

The view hierarchy table is queried to get the ordered set of content items for each content declaration, and the content item data inserted into the result set. When merging and ordering results from the cached hierarchy with the non-cached hierarchy, the additional queried to non-cached datasources may be necessary to insure proper ordering of the aggregate is maintained. The constructed result set is persisted for subsequent iteration management. The result set will be discarded when a new search request is received. There is additional overhead and latency when issuing queries to non-cached datasources. Consideration should be given in view definition to limit references to non-cached datasources to points in the hierarchy where they will return data. For example, it would be inefficient to declare a non-cached datasource at the root of the hierarchy if that datasource will only provide audio content.

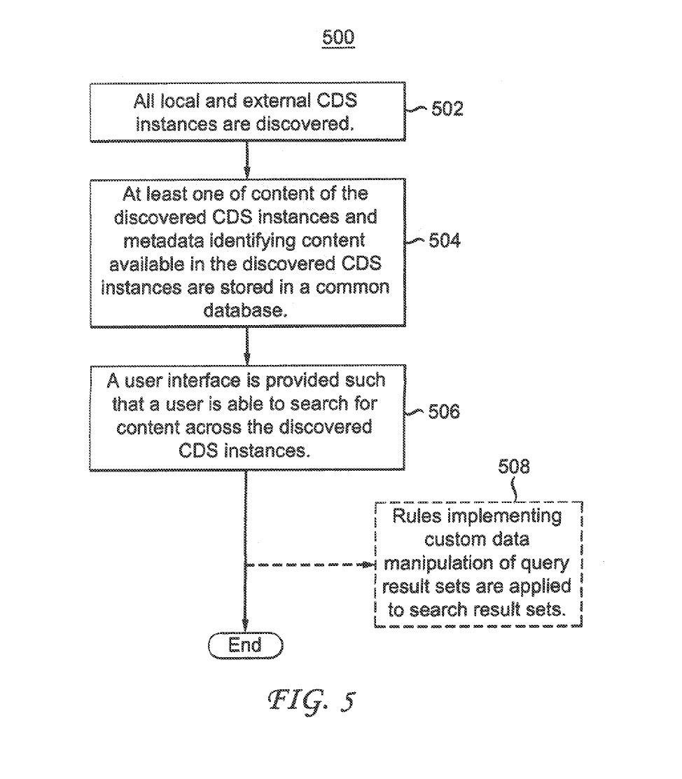

FIG. 5 depicts a flow diagram of a method for aggregating content from local and remote sources for enabling the performance of an efficient search in accordance with an embodiment of the present invention. The method 500 of FIG. 5 begins at step 502 during which all local and external CDS instances are discovered. For example and as described above, the discovery of local and external CDS instances can include at least one of communicating directly with local content directory service devices to exchange data and information, identifying local content directory service devices using a local digital media server to exchange data and information, using a local control point component data model and control point interfaces to exchange data and information with external content directory service devices and using a content provider plug-in device's API to implement interfaces to content and metadata of the content provider plug-in device. The method 500 can then proceed to step 504.

At step 504, at least one of content of the discovered CDS instances and metadata identifying content available in the discovered CDS instances are stored in a common database. As described above, in one embodiment of the present invention, the common database comprises a de-serialized database which provides use of indexes for enabling searches. The method 500 can then proceed to step 506.

At step 506, a user interface is provided such that a user is able to search for content across the discovered CDS instances. As described above, in one embodiment of the present invention the user interface can include a logical view which can take the form of a hierarchical tree. The method 500 can then proceed to optional step 508 or can be exited.

At optional step 508, rules implementing custom data manipulation of query result sets are applied to search result sets. In one embodiment of the present invention, such rules are applied prior to presenting search results to a search requester/user. The method 500 can then be exited.

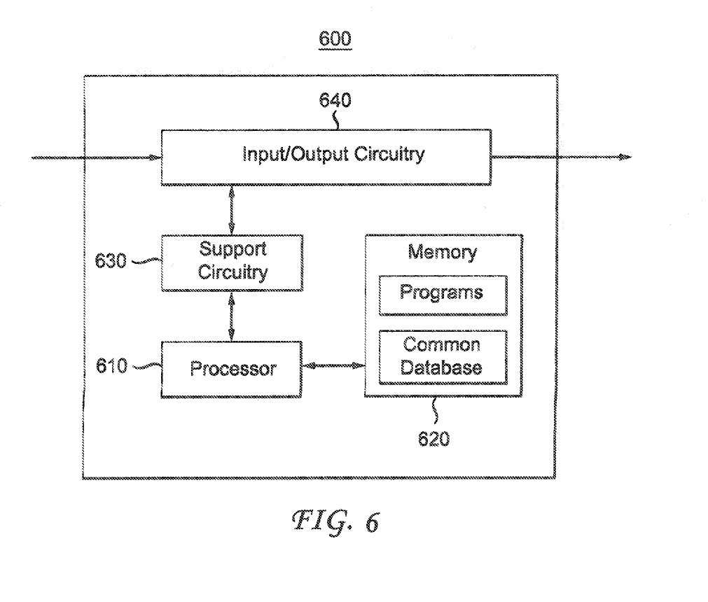

FIG. 6 depicts a high level block diagram of a CMS device 600 for aggregating server based and LAN based media content and information for enabling an efficient search in accordance with an embodiment of the present invention. More specifically, the CMS device 600 of FIG. 6 illustratively comprises a processor 610 as well as a memory 620 for storing control programs, file information, stored media and the like. The CMS device 600 cooperates with conventional support circuitry 630 such as power supplies, clock circuits, cache memory and the like as well as circuits that assist in executing the software routines stored in the memory 620. As such, it is contemplated that some of the process steps discussed herein as software processes may be implemented within hardware, for example, as circuitry that cooperates with the CMS device 600 to perform various steps. The CMS device 600 also contains input-output circuitry 640 that forms an interface between various functional elements communicating with the CMS device 600.

Again, although the CMS device 600 of FIG. 6 is depicted as a general purpose computer that is programmed to perform various control functions in accordance with the present invention, the invention can be implemented in hardware, for example, as an application specified integrated circuit (ASIC). As such, the process steps described herein are intended to be broadly interpreted as being equivalently performed by software executed by a processor, hardware, or a combination thereof. In addition, although the CMS device 600 of FIG. 6 is depicted as a separate component, the functionalities of the CMS device 600 in accordance with the concepts and embodiments of the present invention described herein can be incorporated into an existing content management system component such as a set-top box, personal video recorder, digital video recorder or content provider server and the like.

Having described various embodiments for a method and apparatus for aggregating server based and LAN based media content and information for enabling an efficient search (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A method, comprising:
discovering local and external content directory service instances;
storing at least one of content of the discovered content directory service instances and metadata identifying content available via the discovered content directory service instances in a common database; and
providing a user interface such that a user is able to search for content across the discovered content directory service instances.

2. The method of claim 1, wherein discovering local content directory service instances comprises communicating directly with local content directory service devices to exchange data and information.

3. The method of claim 1, wherein discovering local content directory service instances comprises identifying local content directory service devices using a local digital media server to exchange data and information.

4. The method of claim 1, wherein discovering external content directory service instances comprises using a local control point component data model and control point interfaces to exchange data and information with external content directory service devices.

5. The method of claim 1, wherein discovering content directory service instances comprises using a content provider plug-in device's API to implement interfaces to content and metadata of the content provider plug-in device.

6. The method of claim 1, wherein said common database comprises a de-serialized database which provides use of indexes for enabling searches.

7. The method of claim 1, comprising performing a search on the content and metadata stored in the common database and sorting and ordering a result of the search.

8. The method of claim 1, wherein content and metadata unable to be stored in the common database is sorted and ordered separately during a search and results are merged with a result of a local search on the content and metadata stored in the common database, which is sorted and ordered.

9. The method of claim 1, comprising querying content and metadata unable to be stored in the common database via a content provider plug-in.

10. The method of claim 1, wherein said user interface comprises a logical view of the content directory service instances and related content and metadata.

11. The method of claim 10, wherein said logical view comprises a hierarchical tree diagram.

12. An apparatus comprising:
a memory for storing program routines and data; and
a processor for executing said program routines, said processor, when executing said program routines, configured to perform the steps of:
discovering local and external content directory service instances;
storing at least one of content of the discovered content directory service instances and metadata identifying content available via the discovered content directory service instances in a common database; and
providing a user interface such that a user is able to search for content across the discovered content directory service instances.

13. The apparatus of claim 12, wherein said memory comprises a common database.

14. The apparatus of claim 13, wherein said common database comprises a de-serialized database which provides use of indexes for enabling searches.

15. The apparatus of claim 13, wherein said apparatus communicates directly with local content directory service devices using an exposed API to exchange data and information.

16. The apparatus of claim 13, wherein said apparatus communicates with a local digital media server to exchange data and information with local content directory service instances.

17. The apparatus of claim 13, wherein said apparatus uses a local control point component data model and control point interfaces to exchange data and information with external content directory service devices.

18. The apparatus of claim 13, wherein said apparatus uses a content provider plug-in device's API to implement interfaces to content and metadata of the content provider plug-in device.

19. The apparatus of claim 13, wherein said apparatus sorts and orders content and metadata stored in the common database.

20. The apparatus of claim 13, wherein said apparatus sorts and orders content and metadata unable to be stored in the common database separately and results are merged with content and metadata stored in the common database which is sorted and ordered.
